(19) United States
(12) Patent Application Publication
(10) Pub. No.: US 2008/0100529 A1
(43) Pub. Date: May 1, 2008

(54) ANTENNA WITH LATTICE SUPPORT STRUCTURE

(75) Inventors: JAMES H. KEMMAN, Newburgh, IN (US); Ronald Lile, Lynnville, IN (US); Ernie Jones, Evansville, IN (US); John Robinson, Newburgh, IN (US)

Correspondence Address: C RICHARD MARTIN;MARTIN & MARTIN, ATTORNEYS AT LAW, PC, PO BOX 29, BOONVILLE, IN, 47601, US

(73) Assignee: ELECTRONICS RESEARCH, INC., Chandler, IN (US)

(21) Appl. No.: 11/739,425

(22) Filed: Apr. 24, 2007

Related U.S. Application Data
(60) Provisional application No. 60/745,516, filed on Apr. 24, 2006.

(51) Int. Cl. H01Q 1/12

(52) U.S. Cl. 343/878

(57) ABSTRACT

A transmitting antenna having a lattice-type support structure is provided through the confines of which the transmission lines may be routed so that the supporting structure itself may serve as a screen, shielding the transmission lines from the radiated field, while permitting generation of a satisfactory radiation pattern. A transmitting antenna is provided having an electrically conductive supporting structure, a plurality of radiating elements, and a plurality of antenna excitation conductors. The electrically conductive support structure includes a plurality of vertical support members connected to adjacent vertical support members by a plurality of horizontal support members. The radiating elements are affixed to the electrically conductive supporting structure and extend outwardly therefrom. The antenna excitation conductors carry excitation energy to the radiating elements, and are positioned within the electrically conductive supporting structure, thereby allowing the supporting structure to serve as a screen, shielding the transmission lines from the radiated field.

### BACKGROUND OF INVENTION

The present invention relates to a manner of exciting antenna radiating elements which are mounted on an electrically conductive supporting structure, and more particularly to the arrangement of the antenna excitation conductors which carry excitation energy to the radiating elements.

In prior art devices, the antenna excitation conductors, or transmission lines and other radio frequency energy distribution components, are positioned external to the antenna support structure and therefore are exposed to the electric and magnetic fields radiated by the antenna radiating elements. These fields tend to excite secondary currents and voltages in the transmission lines, which secondary currents and voltages cause undesirable changes to the antenna excitation energy.

To avoid such undesirable changes, it has been common practice for years to surround the antenna transmission lines with tubular shield conductors, usually one shield conductor for each antenna excitation conductor. However, the tubular shield conductors themselves pose additional problems, in that they are likewise exposed to the electric and magnetic fields radiated by the antenna radiating elements, inducing in them certain currents and voltages from the radiated fields. These currents and voltages have been found to be greatly influenced by a number of factors including: a) the proximity of the shield conductors to the radiating elements; b) orientation of the shield conductors with respect to the radiating elements; c) proximity of the shield conductors to other shield conductors; d) orientation of the shield conductors with respect to the other shield conductors; e) proximity of the shield conductors to members of the conductive support structure; f) orientation of the shield conductors wit respect to members of the conductive support structure; and g) the number and location of any electrical connections between the shield conductors and other shielded conductors or members of the conductive support structure.

The complexity of the situation together with sensitivity to small physical changes renders prediction and analysis by computational methods both difficult and imprecise. Unfortunately, when the induced currents and/or voltages become sufficiently large, the result can be one or more of the following: 1) adverse effect upon the radiated field pattern of the antenna; 2) adverse effect on the impedance bandwidth of the antenna; 3) adverse effects on the coupling between/among multiple antenna radiating elements and/or multiple antennas taken as a whole; 4) destruction of equipment by excessive heating; 5) destruction of equipment due to arcing between closely proximate conductive objects; and/or 6) generation of spurious radio signals. In general, the last three of these effects become more severe as operating power is increased.

Attempts have been made to overcome the problems associated with induced currents and voltages in the transmission lines as discussed above. One such attempt includes spacing the conductors as far from the radiating elements and/or as close to neutral conductive elements (e.g. the support structure) as possible or practical. Another possible scenario is to establish frequent electrical or radio-frequency connection between the conductors or the tubular shield conductors and neutral conductive elements. Conductive screening material has also been interposed between the transmission lines and the antenna radiating elements.

### SUMMARY OF INVENTION

The present invention overcomes these problems by providing a suitable lattice-type support structure through the confines of which the transmission lines may be routed so that the supporting structure itself may serve as a screen, shielding the transmission lines from the radiated field, while permitting generation of a satisfactory radiation pattern.

According to one preferred embodiment of the invention a transmitting antenna comprising an electrically conductive supporting structure, a plurality of radiating elements, and a plurality of antenna excitation elements is provided. The electrically conductive supporting structure includes a plurality of vertical support members connected to adjacent vertical support members by a plurality of horizontal support members. The radiating elements are affixed to the electrically conductive supporting structure and extend outwardly therefrom. The plurality of antenna excitation conductors carry excitation energy to the radiating elements, and are positioned within the electrically conductive supporting structure. In addition, diagonal support members extending between corresponding adjacent vertical support members may be provided for additional support and shielding.

Each one of the plurality of radiating elements may be positioned on a corresponding one of said vertical support members, or alternatively may be positioned on a corresponding one of said horizontal support members. The number of vertical support members may be any number greater than two, and according to the presently preferred embodiments may comprise three, four or five vertical support members, arranged in triangular, square, or pentagonal configurations, respectively.

The radiating elements according to one aspect of the present invention may be batwing antenna elements. The antenna excitation conductors may include one or more main feed lines and a plurality of secondary transmission lines connected to and corresponding to said plurality of radiating elements.

According to one presently preferred embodiment, four vertical support members are provided arranged in a square cross section configuration. Four corresponding radiating elements, which may preferably be batwing antenna elements, are positioned one on each one of the four vertical support members. The antenna excitation conductors preferably include a pair of main feed lines and four pairs of secondary transmission lines, one pair of each of said four pairs of secondary transmission lines being connected to a corresponding antenna element.

According to another presently preferred embodiment, a transmitting antenna is provided comprising support means having a first end anchored to the ground and a second end extending vertically upward from said first end; means for radiating a signal affixed to the support means and extending outwardly therefrom; and means for carrying excitation energy to the radiating means, said excitation energy carrying means being positioned within the support means.

The support means may include a lattice support tower having a plurality of substantially vertical components spaced a distance apart from one another, and a plurality of stabilizing support members connecting each of said substantially vertical support members to adjacent substantially vertical support members. The plurality of stabilizing support members may include a plurality of substantially horizontal support members and a plurality of substantially diagonal support members extending between adjacent substantially vertical support members. The transmitting antenna may further include a screening material covering said plurality of stabilizing support members.

Accordingly, it is an object of the present invention to provide a suitable lattice-type support structure through the confines of which the transmission lines may be routed so that the supporting structure itself may serve as a screen, shielding the transmission lines from the radiated field, while permitting generation of a satisfactory radiation pattern.

These and other objects, features and advantages of the present invention will become apparent with reference to the text and the drawings of this application.

### BRIEF DESCRIPTION OF THE DRAWINGS

FIG. 1 shows a perspective view of an antenna support structure and radiating elements according to a first embodiment of the present invention.

FIG. 2 shows a cross sectional view of the antenna of FIG. 1 along the plane 2-2.

FIG. 3 shows a perspective view of an antenna support structure and radiating elements according to a second embodiment of the present invention.

FIG. 4 shows a cross sectional view of the antenna of FIG. 3 along the plane 4-4.

FIG. 5 shows a cross sectional view of an antenna support structure and radiating elements according to an alternative embodiment of the invention.

FIG. 6 shows a perspective view of an antenna support structure and radiating elements according to an alternative preferred embodiment of the present invention.

FIG. 7 shows a cross sectional view of the antenna of FIG. 6 along the plane 7-7.

FIG. 8 shows a perspective view of an antenna support structure and radiating elements according to an alternative preferred embodiment of the present invention.

FIG. 9 shows a cross sectional view of the antenna of FIG. 6 along the plane 9-9.

### DESCRIPTION OF PREFERRED EMBODIMENTS

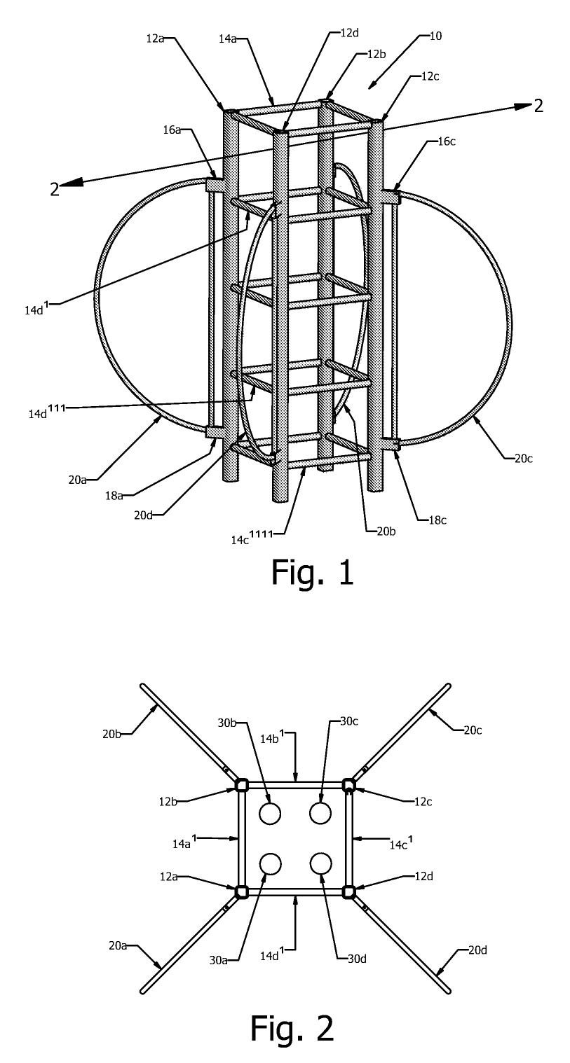

FIGS. 1 and 2 show the invention according to a first preferred embodiment. The invention comprises an electrically conductive supporting structure 10 carrying a plurality of radiating elements 20. The supporting structure 10 supports radiating elements 20 of an antenna and also forms part of the antenna. Supporting structure 10 is a part of the radiating portion of the antenna. The supporting structure 10 also provides certain protection of the feed components (e.g. transmission lines 30) of the antenna, including but not limited to, reduced induced currents on the feed components. The supporting structure 10 and radiating elements 20 attached form the radiating antenna.

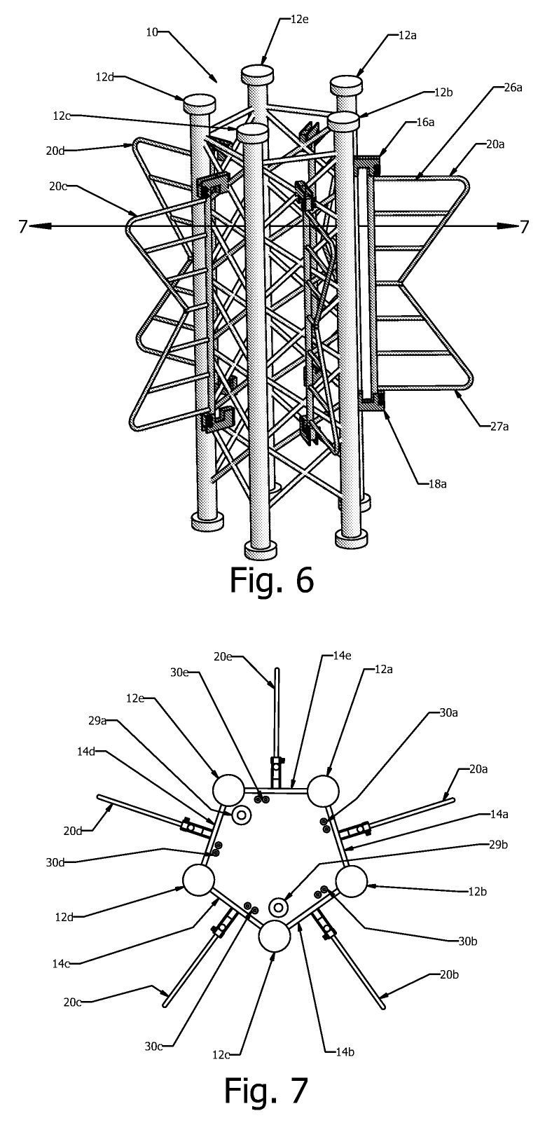

The support structure shown in FIGS. 1-4 includes four vertical support members 12a, 12b, 12c, 12d forming a support structure having a square cross section as shown in FIGS. 2 and 4. The invention is not limited to a 4-sided support structure 10, and it is contemplated that support structures having a variety of polygonal shapes—triangular (FIG. 5), pentagonal (FIGS. 6 and 7), octagonal, etc.—may be utilized by providing the appropriate number of vertical support members. The vertical support members shown in FIGS. 1-4 have a square cross-section. The shape of the vertical support members may also be modified to correspond to the shape of the support structure generally. In addition, the vertical support members may by round.

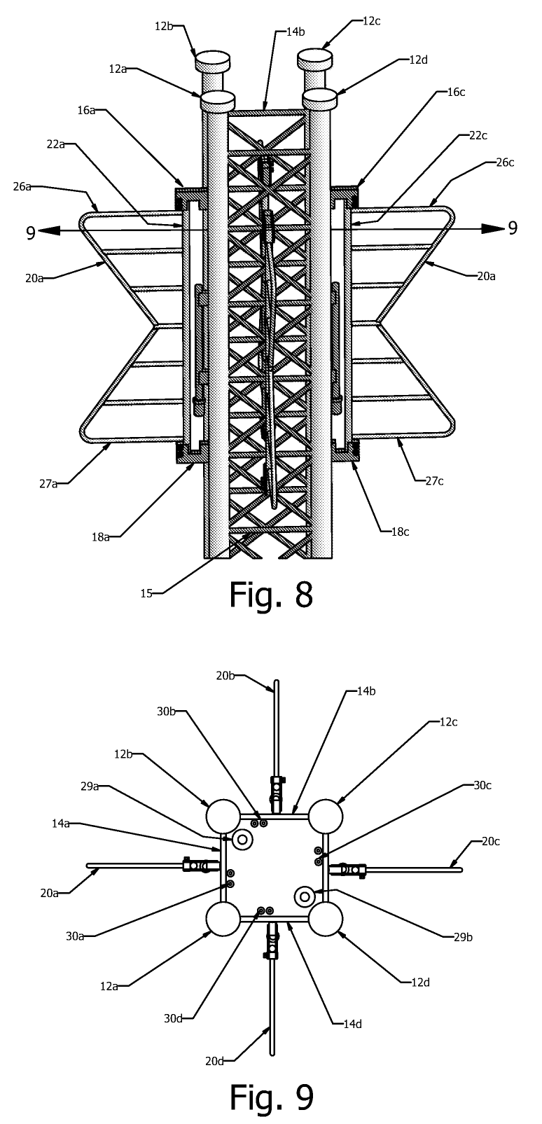

The support structure 10 also includes a plurality of horizontal support members 14a, 14b, 14c, 14d between and attached to each of the adjacent vertical support members 12a, 12b, 12c, 12d providing sufficient strength for the structure to be self supporting. Several sets of horizontal support members—e.g. 14a′-d′, 14a″-d″, 14a′″-d′″, 14a″″-d″″, may be provided along the length of the support structure to add stability to the support structure 10. As best shown in FIG. 8, the support structure 10 may also include a plurality of diagonal support members 15. The diagonal support members 15 provide additional structural stability to the antenna, and also provide additional shielding between the radiating elements 20 and transmission lines 30.

A plurality of radiating elements 20a, 20b, 20c, 20d are attached to the supporting structure 10 by way of respective upper mounting brackets 16a, 16b, 16c, 16d and lower mounting brackets 18a, 18b, 18c, 18d. The radiating elements may be of any shape desired and known in the art. As shown in FIGS. 1-4, the radiating element may be arc-shaped, with an intermediate conductive rod 22 connecting the two ends of the arc-shaped element 24 at the respective upper mounting bracket 16 and lower mounting bracket 18. As shown in FIGS. 6-9, the radiating element may be a bat-wing radiating element having an upper terminating rod 26 and a lower terminating rod 27 attached to the support structure 10 by respective upper mounting bracket 16 and lower mounting bracket 18.

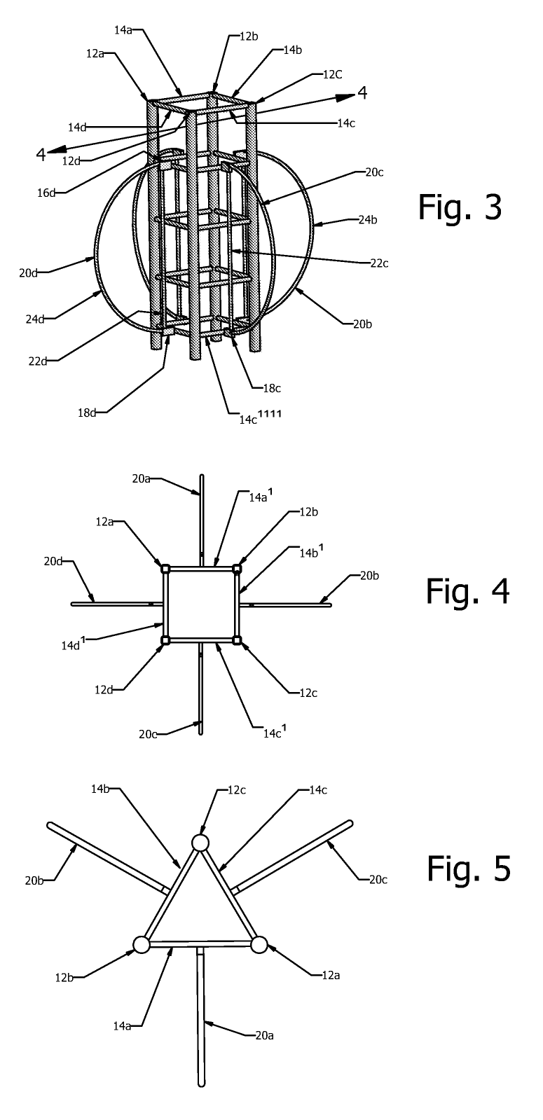

As shown in FIG. 1 and 2, the radiating elements 20a, 20b, 20c, 20d may be attached to the supporting structure at the corners thereof by attaching the mounting brackets 16, 18 to the corresponding vertical support members 12. Alternatively, as shown in FIGS. 3 and 4, the radiating elements 20a, 20b, 20c, 20d may be attached to the faces of the supporting structure 10 by attaching the mounting brackets 16,18 to the corresponding horizontal support members 14. By providing for alternate radiating element mounting positions, a multitude of radiating patterns may be accommodated.

The antenna excitation conductors include at least a pair of main feed lines 29a, 29b, and secondary transmission lines 30a, 30b, 30c, 30d, which are fed up the antenna through the open space inside of the electrically conductive support structure 10. The secondary transmission lines 30a, 30b, 30c, 30d are then connected to the radiating elements 20a, 20b, 20c, 20d in a conventional manner. This effectively reduces the induced currents and voltages on the transmission lines by enclosing them within the conductive support structure 10 which acts as a screen. Additional screening material, such as a wire-mesh screen may be placed over the outer surfaces of the support structure 10 to provide further reduction of the induced currents and voltages on the transmission lines. It is also contemplated that the electrically conductive supporting structure could be a cylindrical support structure with openings of sufficient size to permit feeding of the antenna excitation conductors within the interior thereof. In addition, the support structure provides additional protection to the transmission lines from environmental conditions.

In view of the forgoing it may be seen that the several advantages of the present invention have been achieved and that other advantageous results have been attained.

As various changes could be made in the above constructions without departing from the scope of the invention, and that various other formulas could be applied but which could be reduced mathematically and practically to the formulas of this invention, it should be understood that all matters contained in the above description or shown in the accompanying drawings shall be interpreted as illustrative and not in a limiting sense.

What is claimed is:

1. A transmitting antenna comprising:
an electrically conductive supporting structure having a plurality of vertical support members connected to adjacent vertical support members by a plurality of horizontal support members;
a plurality of radiating elements affixed to the electrically conductive supporting structure and extending outwardly therefrom; and
a plurality of antenna excitation conductors which carry excitation energy to the radiating elements, wherein the plurality of antenna excitation conductors are positioned within the electrically conductive supporting structure.

2. The transmitting antenna according to claim 1, wherein each one of said plurality of radiating elements is positioned on a corresponding one of said vertical support members.

3. The transmitting antenna according to claim 1, said plurality of vertical support members comprises three vertical support members.

4. The transmitting antenna according to claim 3, wherein the three vertical support members are arranged in a triangular cross section configuration.

5. The transmitting antenna according to claim 1, said plurality of vertical support members comprises four vertical support members.

6. The transmitting antenna according to claim 5, wherein the four vertical support members are arranged in a square cross section configuration.

7. The transmitting antenna according to claim 1, said plurality of vertical support members comprises five vertical support members.

8. The transmitting antenna according to claim 7, wherein the five vertical support members are arranged in a pentagonal cross section configuration.

9. The transmitting antenna according to claim 1, wherein each one of said plurality of radiating elements is positioned on corresponding horizontal support members.

10. The transmitting antenna according to claim 1, wherein the plurality of radiating elements are a plurality of batwing antenna elements.

11. The transmitting antenna according to claim 1, wherein said plurality of antenna excitation conductors comprises one or more main feed lines and a plurality of secondary transmission lines connected to and corresponding to said plurality of radiating elements.

12. The transmitting antenna according to claim 1, wherein said plurality of vertical support members comprises four vertical support members arranged in a square cross section configuration, and said plurality of radiating elements comprises four antenna elements, wherein each one of said four antenna elements is positioned on a corresponding one of said vertical support members.

13. The transmitting antenna according to claim 12, wherein said plurality of antenna excitation conductors comprises a pair of main feed lines and four pairs of secondary transmission lines, one pair of each of said four pairs of secondary transmission lines being connected to a corresponding antenna element.

14. The transmitting antenna according to claim 13, wherein the plurality of radiating elements are a plurality of batwing antenna elements.

15. The transmitting antenna according to claim 1, further comprising a plurality of diagonal support members extending between corresponding adjacent vertical support members.

16. A transmitting antenna comprising:
support means having a first end anchored to the ground and a second end extending vertically upward from said first end;
means for radiating a signal affixed to the support means and extending outwardly therefrom; and
means for carrying excitation energy to the radiating means, said excitation energy carrying means being positioned within the support means.

17. The transmitting antenna according to claim 16, wherein said support means comprises a lattice support tower having a plurality of substantially vertical components spaced a distance apart from one another, and a plurality of stabilizing support members connecting each of said substantially vertical support members to adjacent substantially vertical support members.

18. The transmitting antenna according to claim 17, wherein the plurality of stabilizing support members include a plurality of substantially horizontal support members and a plurality of substantially diagonal support members extending between adjacent substantially vertical support members.

19. The transmitting antenna according to claim 17, further comprising a screening material covering said plurality of stabilizing support members.
